(19) United States
(12) Patent Application Publication
(10) Pub. No.: US 2025/0305928 A1
(43) Pub. Date: Oct. 2, 2025

(54) Cantilever and Graphene-based Piezo Resistor

(71) Applicant: RealTime7 Inc., Brantford (CA)

(72) Inventor: Adwait P. Kulkarni, Brantford (CA)

(21) Appl. No.: 19/094,745

(22) Filed: Mar. 28, 2025

Related U.S. Application Data
(60) Provisional application No. 63/571,219, filed on Mar. 28, 2024.

(51) Int. Cl. G01N 15/1031; H01C 1/14; H01C 13/00

(52) U.S. Cl. CPC G01N 15/1031; H01C 1/14; H01C 13/00

(57) ABSTRACT

The composite piezo resistive sensor device is a sensor device with high sensitivity, as well as unique and novel properties. More specifically, the device has a combination of a 3-D structure and a graphene mesh. The device has a cantilever structure that can be used to detect impulses in the surrounding environment to identify characteristics such as kinetic energy, resonant frequency, mass, density, shape, surface features, and inertial moments to infer the presence and prevalence of impulse sources. The composite silicon and graphene structure creates a mechanical moment of inertia that amplifies localized deformation and induces unique harmonic modes in the piezo resistor. The composite piezo resistor is much more sensitive and produces richer, continuous signal outputs without requiring surface functionalization, and it therefore has the ability to assay a wide range of micro and nano particles, as well inferring more generally the presence of impulse sources.

### FIELD OF THE INVENTION

The present invention generally relates to a piezoresistive sensor. More specifically, the present invention is composite cantilever structure and graphene-based piezo resistor for measuring and transmitting impulses.

### BACKGROUND OF THE INVENTION

A piezo resistor is a device, often made from a semiconductor material, whose electrical resistance changes when subjected to mechanical stress or strain, making it useful for measuring pressure, force, and other mechanical inputs. Particle sensors such as quartz and doped silicon based piezo resistors attached to silicon cantilevers have previously been developed. These require comparatively larger forces to create detectable outputs, necessitating specialized receptors to bind to particles. Silicon based cantilevers have been developed with piezoresistive material such as doped silicon and quartz, but not with graphene. 2-D graphene meshes have been researched for their piezo resistive properties but have not been combined with a silicon structure to form a composite piezo resistor. The current sensing methods using silicon structures suffer from three problems:
a. Lack of sensitivity
b. Lack of generality
c. Lack of signal richness

The lack of sensitivity occurs due to the relatively large force required to create a measurable difference in the crystalline structure of existing piezoresistive materials currently used with silicon nanostructures. These include doped silicon or quartz-based crystals. The larger force and lower gauge factor of such piezoresistive materials used with silicon nanostructures restricts their sensitivity and dampens the output response.

The lack of generality relates to the inability of a single silicon nanostructure to detect broad categories of particles due to their specific functionalization that binds selectively with the target particle or with a limited group of particles. Functionalization may be needed due to the larger forces required by piezo resistors currently used with silicon nanostructures, precluding measurement through Brownian motion, Van Der Waals, and similar more temporary particle interactions, as these produce impulses too weak or too fast to be measured given the sensor limitations.

The lack of signal richness refers to the binary nature of interaction. Mass changes from surface functionalization can produce quantized step functions, which turn on or off as particular receptors bind with particles, but they may not contain rich continuous time domain signals which can encode subtle information which differentiates between particle species of similar masses and shapes. The composite silicon and graphene nanostructure creates mechanical moments that amplify localized deformation and induce unique harmonic modes in the piezo resistor. The composite piezo resistor is much more sensitive and produces richer, continuous signal outputs without requiring surface functionalization, and is therefore broad spectrum in its ability to assay micro and nano particles.

In another area of research with 2-D graphene sheets, work has been done in the development of graphene based piezoelectric and piezoresistive materials. Some are using 2-D piezoelectric graphene sheets in various geometries as motion sensors. These are planar two-dimensional structures which have a piezoelectric change of high sensitivity. Monolayer graphene exhibits a high gauge factor which is the amount of change in electrical resistance as a function of mechanical deformation. However, these 2-D sheets do not amplify or isolate particle interactions in the same way due to lacking a moment of inertia that grows at the square of the perpendicular distance. Such moments are created through the use of 3-D nanostructures such as cantilevers.

An objective of the present invention is to provide users with a composite graphene based piezo resistor that has a combination of a 3-D (3-dimensional) structure and a graphene structure with unique and novel properties. More specifically, the present invention has a 3-D cantilever structure interacting with a piezoelectric graphene mesh that has a moment of inertia and can be used to detect impulses in the surrounding environment to identify characteristics such as kinetic energy, resonant frequency, mass, density, shape, surface features, and inertial moments to infer the presence and prevalence of impulse sources.

### SUMMARY OF INVENTION

The present invention is a piezo resistor device with high sensitivity, as well as unique and novel properties. More specifically, the present invention is a composite graphene based piezo resistor that has a combination of a 3-D silicon cantilever structure and a graphene mesh. The cantilever structure is acted upon by a moment of inertia to induce strain and mechanical deformation in the graphene mesh when interacting with particles in the surrounding environment. The graphene mesh having a high gauge factor and the 3-D silicon cantilever amplifying mechanical deformations through the moments on the cantilever work together to produce higher changes in electrical resistance. These resistance changes can be measured to characterize particle interactions with high sensitivity. The present invention can be used to detect impulses in the surrounding environment based on particle characteristics such as kinetic energy, resonant frequency, mass, density, shape, surface features, and inertial moments to infer the presence and prevalence of impulse sources. The composite silicon and graphene structure creates a mechanical moment of inertia that amplifies localized deformation and induces unique harmonic modes in the piezo resistor. The composite piezo resistor is much more sensitive and produces richer, continuous signal outputs without requiring surface functionalization, and it therefore has the ability to assay a wide range of micro and nano particles, as well inferring more generally the presence of impulse sources.

### BRIEF DESCRIPTION OF THE DRAWINGS

FIG. 1 is a top-front-left perspective view of the present invention.

FIG. 2 is a side elevational view of the present invention, wherein harmonic vibrations of the cantilever structure are depicted.

FIG. 3 is a schematic illustration of the present invention after a first step of the process of creating one unit of the present invention's piezo resistive sensor, which shows a first substrate, such as silicon, to build the structure upon.

FIG. 4 is a schematic illustration of the present invention after a second step of the process, which is after depositing a catalyst deposit.

FIG. 5 is a schematic illustration of the present invention after a third step of the process, which is after depositing a second substrate.

FIG. 6 is a side elevational view of the present invention showing the first substrate and the second substrate.

FIG. 7 is a sectional view of the present invention, taken along A-A′ of FIG. 6.

FIG. 8 is a schematic illustration of the present invention after the third step of the process, which involves milling away of excess second substrate and creating a grid pattern.

FIG. 9 is a top plan view of the present invention after creating a grid pattern over the second substrate.

FIG. 10 is a schematic illustration of the present invention after the fourth step of the process, which involves creating the cantilever structure.

FIG. 11 is a schematic illustration of the present invention after the formation of the graphene layer over the second substrate and etching away excess second substrate.

FIG. 12 is a side elevational view of a schematic illustration of the present invention's functioning mechanism, wherein particles collide with the silicon beam structure and the collision force is transferred to the graphene mesh, causing strain on the graphene mesh which results in changes in its electrical characteristics, such as resistance.

FIG. 13 is a schematic illustration of an equivalent electrical circuit of the present invention (represented as a variable resistor), and the connected external circuit which is required to extract data from the module.

### DETAILED DESCRIPTION OF THE INVENTION

All illustrations of the drawings are for the purpose of describing selected versions of the present invention and are not intended to limit the scope of the present invention.

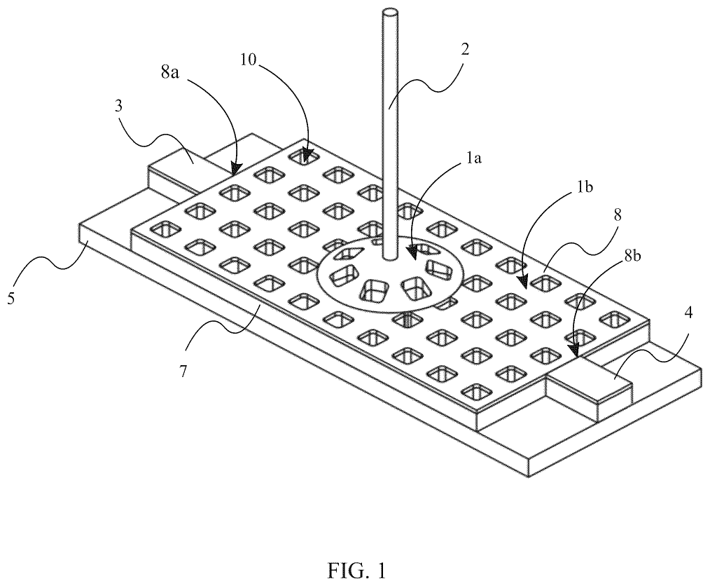

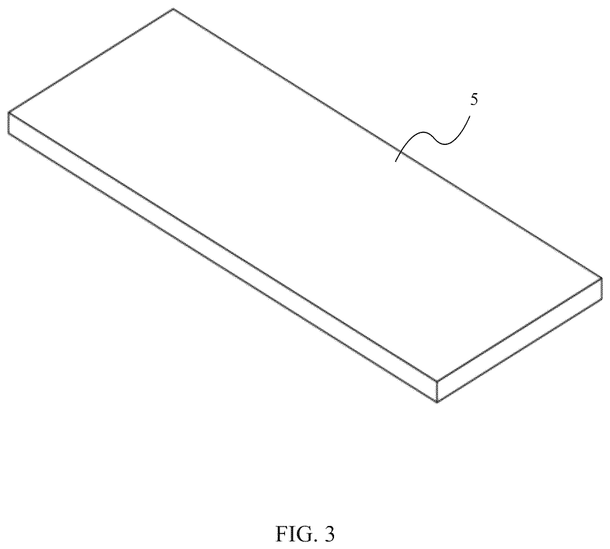

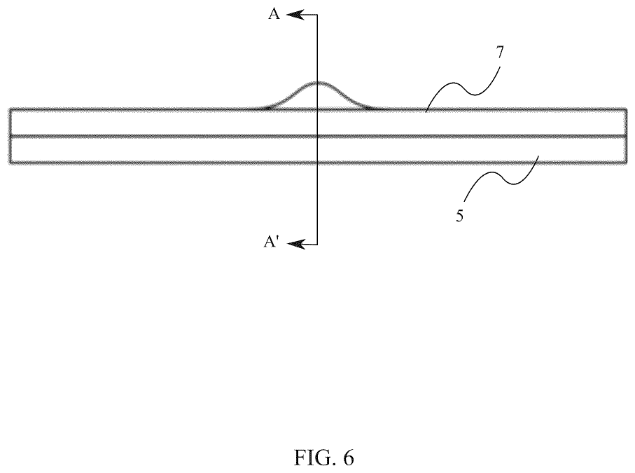

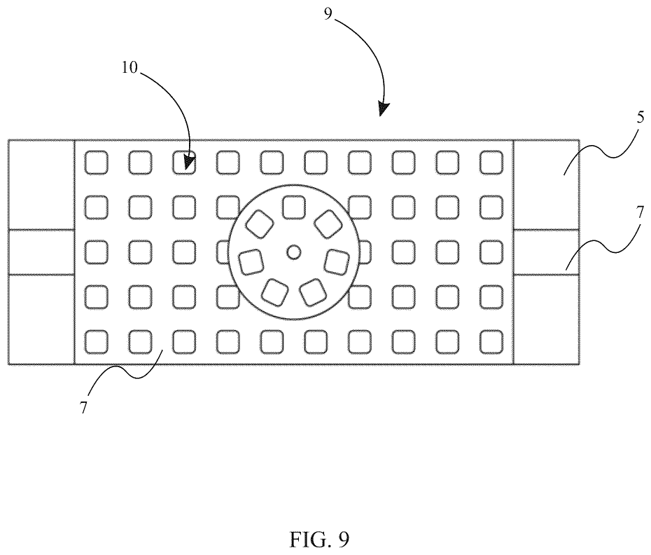

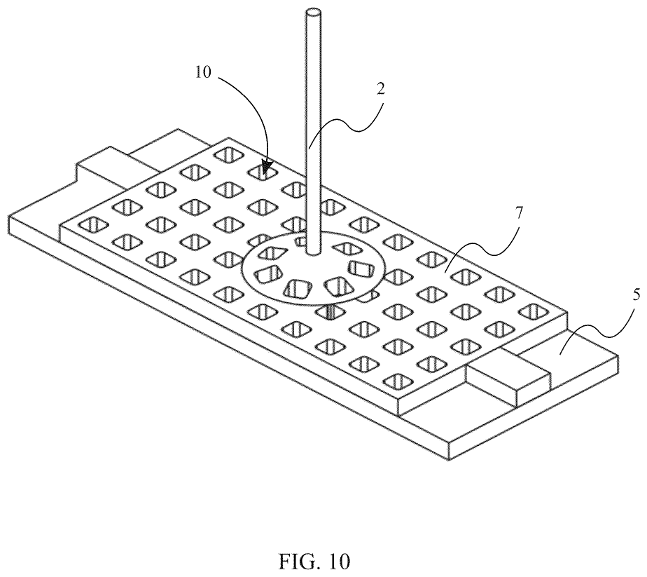

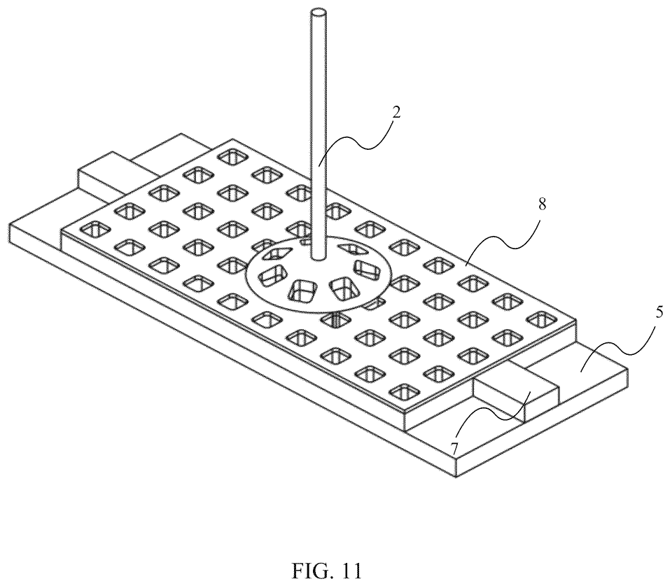

In reference to FIG. 1 through FIG. 13, the present invention is a graphene based composite piezo resistive sensor. The following description is in reference to FIG. 1 through FIG. 13. According to a preferred embodiment, the present invention comprises a base body 1, a cantilever structure 2, a first electrical contact 3, and a second electrical contact 4. The base body 1 is the main structure of the piezo resistive sensor over which other components are built. The cantilever structure 2 is a structure that produces a residual tone or harmonic signal which upon deflection causes the graphene mesh to experience mechanical stress and strain changing its resistance due to the piezoresistive properties of graphene. To that end, the cantilever structure 2 is angularly offset from the base body. In the preferred embodiment, the cantilever structure 2 is a silicon structure or a silicon (Si) probe that has a moment of inertia. More specifically, in the preferred embodiment, the cantilever structure 2 is a perpendicular beam. However, any other material, size, and shape that is known to one of ordinary skill in the art may be used for creating the cantilever structure 2, as long as the intents of the present invention are not altered. As seen in FIG. 1, the cantilever structure 2 is centrally mounted onto the base body 1.

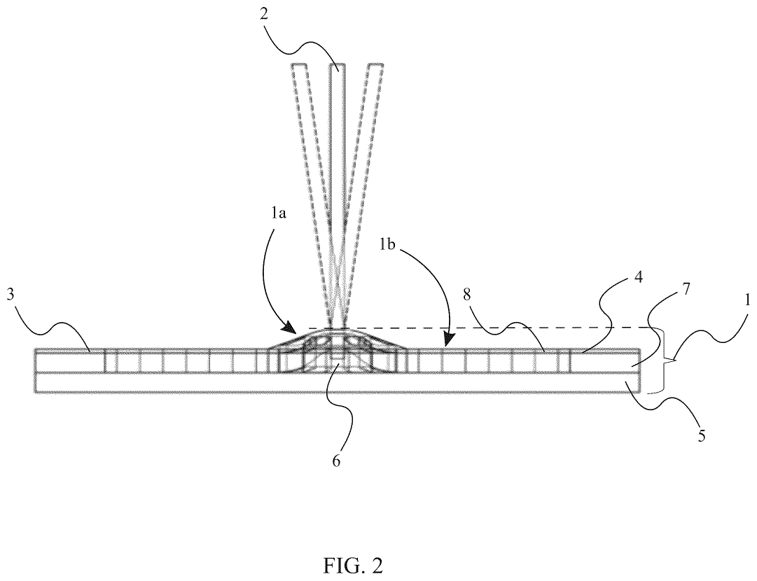

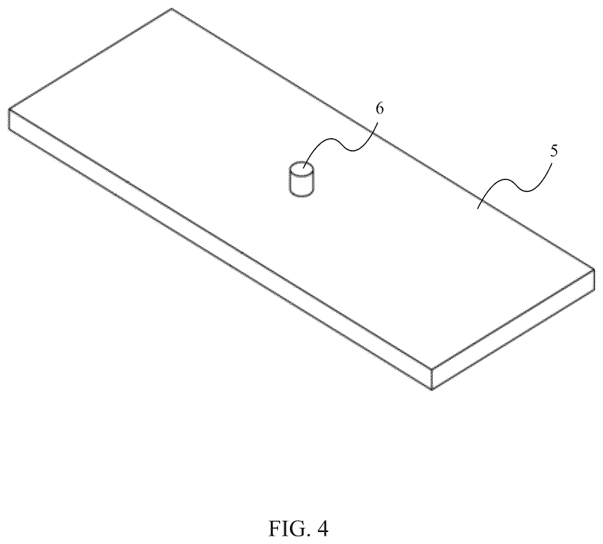

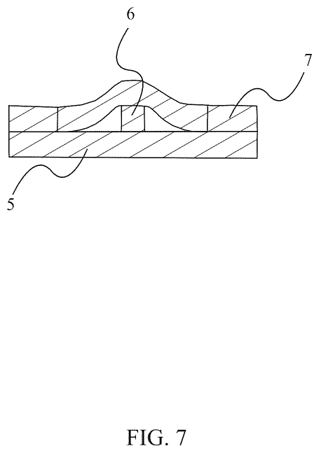

The first electrical contact 3 and the second electrical contact 4 are made of conductive materials, and they support integration of the present invention into an electrical circuit. In other words, any conductive material may be placed or deposited adjacent to the base body 1, to form electrical contacts and establish an electrical circuit with the base body 1. In the preferred embodiment, the base body 1 comprises a first substrate 5, a catalyst deposit 6, a second substrate 7, a graphene layer 8, and a mesh pattern 9. Preferably the first substrate 5 is a silicon (Si) layer or undoped Si wafer, that forms the base onto which the rest of the structure is built upon. The catalyst deposit 6 is a base layer onto which a Si structure or the cantilever structure 2 may be later built upon. As seen in FIG. 4 and FIG. 7, the catalyst deposit 6 is centrally positioned onto the first substrate 5. Further, as seen in FIG. 2, the cantilever structure 2 is terminally mounted onto the catalyst deposit.

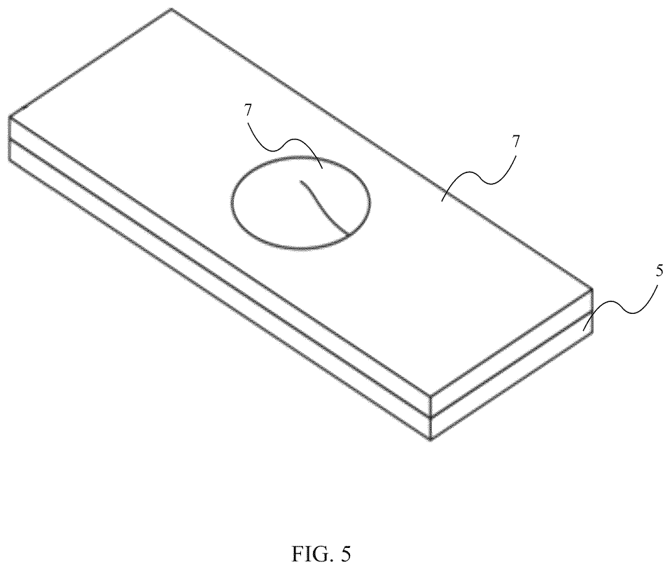

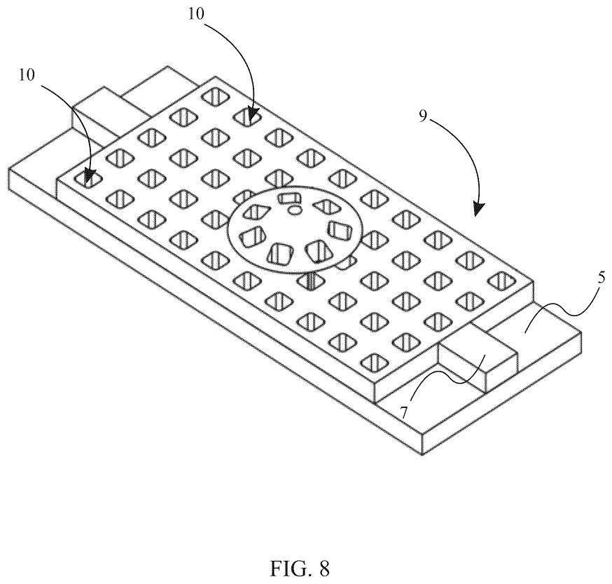

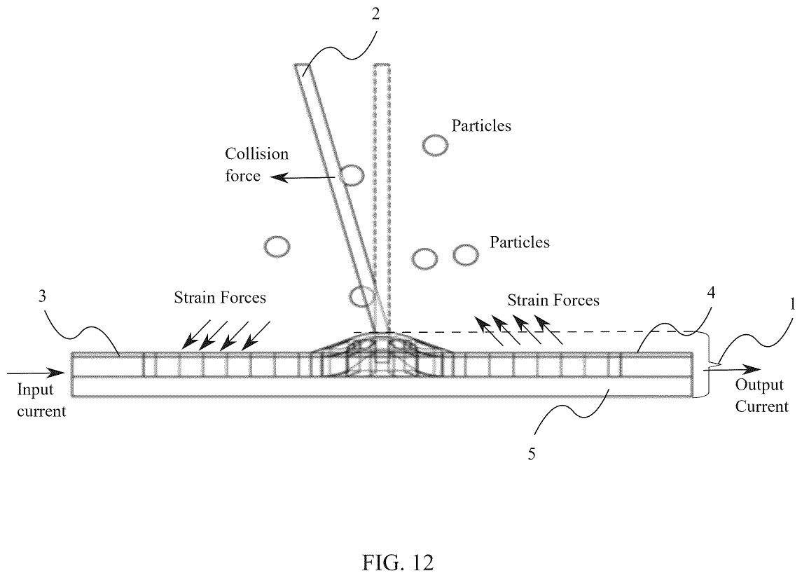

In the preferred embodiment, the catalyst deposit 6 is a gold (Au) segment. However, the catalyst deposit 6 may be any other material, that can grow a silicon, silicon oxide, or a doped silicon-based nanostructure, which is in the preferred embodiment, a wire. The second substrate 7 is a layer of a catalyst or scaffolding material on which graphene can be placed or grown, such as copper. As seen in FIG. 5, the second substrate 7 is overlaid onto the first substrate 5, covering the catalyst deposit 6. Further, the graphene layer 8 is overlaid onto the second substrate 7. The high gauge factor of graphene in this configuration produces significant electrical resistivity changes as a function of relatively small mechanical deformations resulting in high sensitivity. As seen in FIG. 8 through FIG. 10, the mesh pattern 9 comprises a plurality of mesh apertures 10, and the mesh pattern 9 is distributed across the graphene layer 8. Preferably, the plurality of mesh apertures 10 traverses through the graphene layer 8 and the second substrate 7. Further, the plurality of mesh apertures 10 are square in shape. However, the plurality of mesh apertures 10 may be of any shape and dimensions, such as rectangular, oval, etc., as long as the intents of the present invention are not hindered. Furthermore, as seen in FIG. 2 and FIG. 12, the cantilever structure 2 extends through the graphene layer 8 and the second substrate 7 in a direction opposite the first substrate 5. This is so that when particles collide with the silicon beam structure, the collision force is transferred to the graphene mesh, causing strain on the graphene mesh which results in changes in its electrical characteristics, such as resistance. In other words, the cantilever structure 2 is operably coupled to the graphene layer 8, wherein mechanical deflections of the cantilever structure 2 are used to create piezoelectric deflections in the graphene layer 8. In order to measure these changes in electrical characteristics, the first electrical contact 3 is positioned adjacent to a first end 8a of the graphene layer 8, and the second electrical contact 4 is positioned adjacent to a second end 8b of the graphene layer 8, wherein the first end 8a is positioned opposite the second end 8b across the graphene layer 8. It should be noted that the materials and dimensions of the various components used in the present invention may vary, and any other components, and arrangement of components that are known to one of ordinary skill in the art may be used, as long as the intents of the present invention are not altered.

Continuing with the preferred embodiment, and as seen in FIG. 1, the base body 1 comprises a raised region 1a and a flat region 1b. Preferably, the raised region 1a is centrally positioned across the flat region 1b, and the cantilever structure 2 is centrally mounted within the raised region 1a. The particular shape of the raised region 1a is a result of the second substrate 7 and the graphene layer 8 being formed over and around the catalyst deposit 6. In other words, the raised region 1a is constituted by the copper overlapping the gold layer. Further, the flat region 1b is the result of the formation of the second substrate 7 and graphene layer 8 over the planar first substrate 5. The raised region 1a and the surrounding graphene layer 8 that the cantilever structure 2 acts upon to transmit vibrations and stress and strain, interacts with the directionality and flow of electrons between the first electric contact 3 and the second electric contact 4. This interaction further causes a change in the output signal which can be used to characterize the impulse forces. Thus, the raised region 1a and the dimension of the raised region 1a has an impact on the output signal of the piezoresistive sensor device.

In an alternate embodiment, the first electrical contact 3 and the second electrical contact 4 are extensions of the second substrate 7 without the graphene layer overlay. In other words, the first electrical contact 3 and the second electrical contact 4 may be formed by etching away a portion of the second substrate 7 or the copper layer. Similarly, as seen in FIG. 1, the first substrate 5 extends below the first electrical contact 3 and the second electrical contact 4. This further provides structural support for the sensor device.

According to the preferred embodiment, the specific arrangement and materials used for the sensor device help provide the following unique abilities and properties.
a. The finely tunable mass of the silicon nanostructure (cantilever structure 2) the graphene nanostructure (graphene layer 8+mesh pattern 9 (optional)) working together to form the piezo resistor varying from sub-zeptogram to atto-gram mass and larger. The silicon nanostructure (cantilever structure 2) can have a volume on the order of cubic nanometers and the graphene nanostructure (graphene layer 8+mesh pattern 9 (optional)) can be just one atom thick.
b. The high gauge factor of graphene in this configuration produces significant electrical resistivity changes as a function of relatively small mechanical deformations resulting in high sensitivity.
c. The signal amplification by the silicon nanostructure through the mechanical moment of inertia produces continuous data rich harmonics when excited by interactions, enabling measurement of Brownian, Van Der Waals, and other impulses.
   The silicon nanostructure (cantilever structure 2) acts as a cantilever which when deflected and released produces a residual tone or harmonic signal which is a function of
a. The deviation from the central axis of the nanostructure
b. The nature of the impulse, such as a contacting particle's mass, surface features, density, geometry, and dampening characteristics
c. The silicon nanostructure's resonant properties, moment of inertia, mass, and geometry,
d. The configuration, geometry, degrees of freedom, mass, density, harmonic motion, deformation, and electron configuration of the attached piezoelectric graphene nanostructure.
e. The ambient fields and forces produced from the environment around the piezo resistor be it in the solid, liquid, gaseous, or other phase.

A preferred method of making the present invention follows. However, it should be noted that any other method of formation and any other material may be used as the first substrate, the catalyst deposit, and the cantilever structure, as long as the objectives of the present invention are not altered.
Step 1: An undoped silicon wafer is first optionally cleaned with an hydrofluoric acid (HF) dip to remove any oxide layer.
Step 2: The piezo resistor is then constructed by depositing a gold base or multiple gold bases on the silicon substrate. Generally, this can be any substrate that is capable of receiving the gold base. The gold base can be any material that can grow a silicon, silicon oxide, or doped silicon-based nanostructure which in this case is a wire.
Step 3: After the gold base is placed, the copper grid is created. This can be done by first coating the entire surface with a thin film of copper (including the gold base), then milling away the excess copper. Some part of the copper grid may abut or overlap with the gold which can create a raised region. This forms both a mechanical and electrical contact. Alternately the copper and gold may be indirectly connected through the substrate alone, in the case where a gap is present between the two materials. The deposition of gold and copper can be achieved using metallization, lithography, and ion milling techniques in semiconductor fabrication or any other suitable technique.
Step 4: The silicon substrate is placed in a CVD (chemical vapor deposition) chamber and silane-based chemical vapor deposition can be used. In place of silane-based CVD can be any method that can deposit silicon. The exposed gold acts as a catalyst that dissolves silicon, and any similar compatible catalyst or host material can be chosen in place of gold. As the silicon dissolves in the gold, it forms an alloy which super saturates and comes out of solution. This causes a silicon crystal to grow which becomes the silicon wire or nanostructure. The silicon wire also improves bonding to the silicon substrate through the gold alloy. The size of wire will depend on the size of the gold base and the duration of the CVD exposure. It can be grown to nanometer, micrometer, or greater sizes.
Step 5: After the silicon wire formation, the silicon substrate is placed in a graphene CVD chamber. In this case, the copper acts as a catalyst for methane CH₄ or carbon dioxide CO₂ but any gas and any catalyst capable of depositing graphene could be used. A layer of graphene will form over the copper scaffold as a result of CVD.
Step 6: In an optional additional fabrication step, the copper layer can be partly or wholly dissolved using a selective etching agent such as ferric chloride. By controlling the amount of etching through concentration, exposure time, and applicable considerations, it may be possible to increase the range of piezoelectric deflections in the graphene by freeing portions from the copper scaffold, while maintaining sufficient support to retain structural integrity of the composite piezo resistor. At this point the basic piezo resistor is complete, and it can already sample gaseous particles and non-conducting fluids, however a further step can be taken to apply a non-conductive coating such as polytetrafluoroethylene (PTFE). This coating allows the sensor to sample conductive media such as water containing dissolved ions by electrically isolating the piezo resistor from the sampling media exposing selectively the silicon nanostructure as a probe for measuring and transmitting impulses.

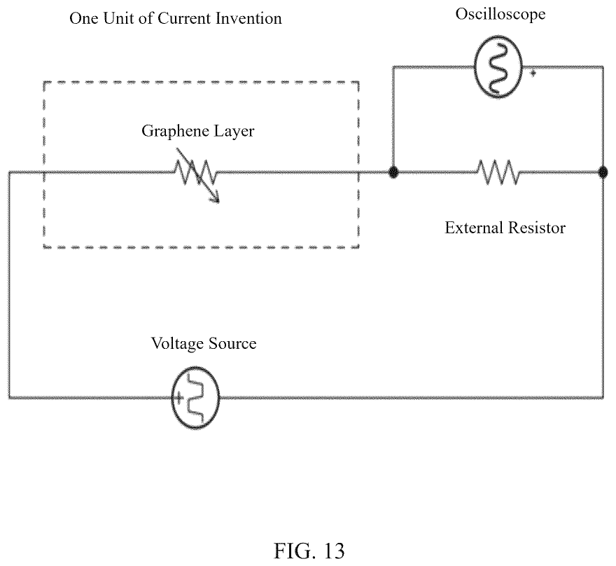

In reference to FIG. 12, the interactions of the fluid and particles within the fluid with the silicon structure causes strain in the graphene mesh. As graphene is a piezo resistor, the structure's electrical resistance changes both during the initial deformation, in the harmonic motion that follows, and in the propagation of surface waves based on the surface-to-surface interaction with the silicon nanostructure. Over the period of interaction, the electrical resistance will change which will produce an electrical signal as a function of time. This can be thought of as a circuit with a variable resistor (FIG. 13). The signal could be measured, for example, as the electrical current flowing through the circuit over the period of the interaction which will vary in time as the resistance changes with the harmonic motion of the silicon nanostructure. Particles striking the silicon structure will have statistical probabilities of interacting in particular ways. Some may strike higher or lower on the structure, at varying angles, and with varying kinetic energy.

When observed over many interactions, a particle of the same species in the same or similar conditions will exhibit repeating signals characterized by a statistical distribution that describes the probability of each type of interaction. If the signals are analyzed using numerical methods and statistical techniques such as Fourier transform it is possible to develop particle signatures, which describe frequency domain values and amplitudes and their statistical likelihoods. If those signatures are harvested when analyzing unknown samples, they can be compared to a database of known signatures to determine relative particle concentration, temperature, pressure, and other characteristics of the test samples.

Although silicon structures with doped silicon and quartz piezo resistors exist, and graphene based planar 2-D piezo resistors exist, the combination of a silicon structure and a graphene structure to form a composite silicon graphene piezo resistor is unique and imbues novel properties. The composite silicon and graphene structure creates a mechanical moment of inertia that amplifies localized deformation and induces unique harmonic modes in the piezo resistor. The composite piezo resistor is much more sensitive and produces richer, continuous signal outputs without requiring surface functionalization, and it therefore has the ability to assay a wide range of micro and nano particles, as well inferring more generally the presence of impulse sources.

Although the invention has been explained in relation to its preferred embodiment, it is to be understood that many other possible modifications and variations can be made without departing from the spirit and scope of the invention as hereinafter claimed.

What is claimed is:

1. A piezo resistive sensor comprising:
a base body;
the base body comprising a first substrate, a catalyst deposit, a second substrate, a graphene layer, and a mesh pattern;
the mesh pattern comprising a plurality of mesh apertures;
a cantilever structure;
a first electrical contact;
a second electrical contact;
the cantilever structure being centrally mounted onto the base body;
the catalyst deposit being centrally positioned onto the first substrate;
the second substrate being overlaid onto the first substrate, covering the catalyst deposit;
the graphene layer being overlaid onto the second substrate;
the mesh pattern being distributed across the graphene layer;
the plurality of mesh apertures traversing through the graphene layer and the second substrate;
the cantilever structure being terminally mounted onto the catalyst deposit;
the cantilever structure extending through the graphene layer and the second substrate opposite the first substrate;
the first electrical contact being positioned adjacent to a first end of the graphene layer;
the second electrical contact being positioned adjacent to a second end of the graphene layer, wherein the first end is positioned opposite the second end across the graphene layer; and
the cantilever structure being operably coupled to the graphene layer, wherein mechanical deflections of the cantilever structure is used to create piezoelectric deflections in the graphene layer.

2. The piezo resistive sensor of claim 1 further comprising:
the base body comprising a raised region and a flat region;
the raised region being centrally positioned across the flat region; and
the cantilever structure being centrally mounted within the raised region.

3. The piezo resistive sensor of claim 1, wherein the cantilever structure is a perpendicular beam.

4. The piezo resistive sensor of claim 1, wherein the cantilever structure is angularly offset from the base body.

5. The piezo resistive sensor of claim 1, wherein the plurality of mesh apertures are squares in shape.

6. The piezo resistive sensor of claim 1, wherein the cantilever structure is a silicon (Si) probe.

7. The piezo resistive sensor of claim 1, wherein the first substrate is a silicon (Si) layer.

8. The piezo resistive sensor of claim 1, wherein the first electrical contact and the second electrical contact are layers of a conductive material.

9. The piezo resistive sensor of claim 1, wherein the first electrical contact and the second electrical contact are extensions of the second substrate without the graphene layer overlay.

10. The piezo resistive sensor of claim 1, wherein the first substrate extends below the first electrical contact and the second electrical contact.

11. The piezo resistive sensor of claim 1, wherein the second substrate is a copper (Cu) layer.

12. The piezo resistive sensor of claim 1, wherein the catalyst deposit is a segment of gold (Au).

13. A piezo resistive sensor comprising:
a base body;
the base body comprising a first substrate, a catalyst deposit, a second substrate, a graphene layer, and a mesh pattern;
the mesh pattern comprising a plurality of mesh apertures;
a cantilever structure;
a first electrical contact;
a second electrical contact;
the cantilever structure being centrally mounted onto the base body, wherein the cantilever structure is a silicon probe;
the catalyst deposit being centrally positioned onto the first substrate;
the second substrate being overlaid onto the first substrate, covering the catalyst deposit;
the graphene layer being overlaid onto the second substrate;
the mesh pattern being distributed across the graphene layer;
the plurality of mesh apertures traversing through the graphene layer and the second substrate;
the cantilever structure being terminally mounted onto the catalyst deposit;
the cantilever structure extending through the graphene layer and the second substrate opposite the first substrate;
the first electrical contact being positioned adjacent to a first end of the graphene layer;
the second electrical contact being positioned adjacent to a second end of the graphene layer, wherein the first end is positioned opposite the second end across the graphene layer; and
the cantilever structure being operably coupled to the graphene layer, wherein mechanical deflections of the cantilever structure is used to create piezoelectric deflections in the graphene layer.

14. The piezo resistive sensor of claim 13 further comprising:
the base body comprising a raised region and a flat region;
the raised region being centrally positioned across the flat region; and
the cantilever structure being centrally mounted within the raised region.

15. The piezo resistive sensor of claim 13, wherein the cantilever structure is a perpendicular beam.

16. The piezo resistive sensor of claim 13, wherein the cantilever structure is angularly offset from the base body.

17. The piezo resistive sensor of claim 13, wherein the first substrate is a silicon (Si) layer.

18. The piezo resistive sensor of claim 13, wherein the first substrate extends below the first electrical contact and the second electrical contact.

19. The piezo resistive sensor of claim 13, wherein the second substrate is a copper (Cu) layer.

20. The piezo resistive sensor of claim 13, wherein the catalyst deposit is a segment of gold (Au).
